(19) United States
(12) Patent Application Publication
(10) Pub. No.: US 2012/0203723 A1
(43) Pub. Date: Aug. 9, 2012

(54) Server System and Method for Network-Based Service Recommendation Enhancement

(75) Inventors: Vincent Huang, Sollentuna (SE); Azadeh Bararsani, Solna (SE); Joakim Söderberg, Solna (SE)

(73) Assignee: Telefonaktiebolaget LM Ericsson (publ), Stockholm (SE)

(21) Appl. No.: 13/021,148

(22) Filed: Feb. 4, 2011

(51) Int. Cl. G06F 15/18

(52) U.S. Cl. 706/20

(57) ABSTRACT

A networked server system for enabling, facilitating and accuracy enhancing personalized service recommendations to a user of a new service S_{N}, comprising an abstract user profile database, a service transformation database, an input/output network interface, and a processing unit adapted and configured to provide user selection functionality, dimension reduction functionality, profile update functionality and service recommendation functionality. The server system is adapted and configured to:
receive, via a network, from a new service S_{N}, a service specific set of user profiles, denoted [P_{N}]∀ U_{N} and having a user dimension and an attribute classification category dimension;
combine the service specific set of user profiles [P_{N}]∀ U_{N} and a set of previously received set of user profiles, denoted [P_{N-1}]∀ U_{N-1}, or a derivative thereof, into a combined set, denoted [cP_{N}]∀ I_{N}, of user profiles for a set of users I_{N}=U_{N}∩U_{N-1};
orthogonally transform [cP_{N}]∀ I_{N} into a set of abstract user profiles, denoted [aP_{N}] ∀ I_{N}, that are minimized in attribute classification dimension; and
reduce, in the attribute classification dimension, the abstract set [aP_{N}]]∀ I_{N} to an abstract reduced set, denoted [arP_{N}] ∀ I_{N}, of the user attributes having the highest variance; thereby enabling enhanced personalized.

### TECHNICAL FIELD

The present invention relates to a system and method for enabling, facilitating and accuracy enhancing personalized network-based service recommendations to a user using a new service over a network.

### BACKGROUND

Usually product recommendation systems used by service providers obtain useful results only after the service has matured enough to have accumulated some critical mass of customer related information. Product recommendations provided to a customer immediately after service market launch is typically less unerring simply because it is based on an insufficient amount of data. The rise of the Internet and its role in e-commerce has resulted in a number of product recommendation systems and methods being developed. The systems attempt to help each customer find a small, more manageable sub-set of products that may be more valuable to him or her from amongst thousands of products. Usually a customer cannot practically browse an entire product description catalogue of products offered by the service provider. In addition, product descriptions do not contain enough relevant information to enable the customer to assess the value of a specific product with respect to his or her concerns and interests.

Many of these recommendation systems utilize techniques such as collaborative or content-based filtering to supplement information available about a customer's individual behavior. It is often technically challenging to define the appropriate group or “neighborhood” of similar customers for a given customer, and also to then predict the individual's preferences from those in the neighborhood with present recommendation systems.

One type of existing product recommendation system is a non-personalized recommendation system. Non-personalized systems recommend products to individual consumers based on averaged information about the products provided by other consumers. The same product recommendations are made to all consumers seeking information about a particular product and all product recommendations are completely independent of any particular consumer.

Another type of existing product recommendation system employs item-to-item correlation to formulate recommendations. Item-to-item systems recommend other products to an individual consumer based on relationships between products already purchased by the consumer or for which the consumer has expressed an interest. The relationships employed typically are brand identity, sales appeal, market distribution, etc. In all cases the information on which the relationships are based is implicit. In other words, no explicit input regarding what the consumer is looking for or prefers is solicited by these systems. Rather, techniques such as data mining are employed to find implicit relationships between products for which the individual consumer has expressed a preference and other products available for purchase. The actual performance of products or whether the consumer ultimately did prefer the products purchased play no part in formulating recommendations with these types of systems.

A third type of existing product recommendation system is an attribute-based system. Attribute-based recommendation systems utilize syntactic properties or descriptive content of available products to formulate their recommendations. In other words, attribute-based systems assume that the attributes of products are easily classified and that an individual consumer knows which classification he or she should purchase without help or input from the recommendation system. Attribute-based systems may implement content-based filtering, where the prediction is blind to data from other users. Collaborative filtering on the other hand, typically records an extended product preference set that can be matched with a collaborative group. In other words, collaborative filters recommend products that similar users have rated highly.

However, present recommendation systems have shortcomings when initially deployed in a newly launched service, where there is no endogenous aggregated user data upon which to base initial recommendations. Today each service needs to have its own endogenous aggregate set of information about users, and each of them captures different aspects of information for them. This is while there might be users common to other services. The information that exist about one same user in different services may overlap or complete one another, and combining them together may “fill blanks” about that user. The raw user data, such as consumption logs, is service specific and may not be available for other services. However, the data in refined from may still be useful for other services. It is a challenge for service providers to share information about the users and still preserve sensitive user data.

### SUMMARY

It is the object of at least some embodiments to obviate at least some of the above disadvantages and provide improved methods, apparatuses and computer media products avoiding the above mentioned drawbacks.

A first aspect of some embodiments of the invention is a networked server system for enabling, facilitating and accuracy enhancing personalized service recommendations. The recommendations may be provided to a user using a new service, denoted S_{N}. The user, the service provider and the recommendation server system are all connected via a network. The networked server system comprises an abstract user profile database, a service transformation database, an input/output network interface, and a processing unit adapted and configured to provide user selection functionality, dimension reduction functionality, profile update functionality and service recommendation functionality. The server system is adapted and configured to in the server:

receive, via a network, from a new service S_{N}, a service specific set of user profiles, denoted [P_{N}]∀ U_{N} and having a user dimension and an attribute classification category dimension;

combine the service specific set of user profiles [P_{N}]∀ U_{N} and a set of previously received set of user profiles, denoted [P_{N-1}]∀ U_{N-1}, or a derivative thereof, into a combined set, denoted [cP_{N}]∀ I_{N}, of user profiles for a set of users I_{N}=U_{N}∩U_{N-1};

orthogonally transform [cP_{N}]∀ I_{N} into a set of abstract user profiles, denoted [aP_{N}] ∀ I_{N}, that are minimized in attribute classification dimension;

reduce, in the attribute classification dimension, the abstract set [aP_{N}]]∀ I_{N} to an abstract reduced set, denoted [arP_{N}] ∀ I_{N}, of the user attributes having the highest variance; thereby enabling enhanced personalized service recommendation to a user comprised in the common set I_{N} of users.

The server system may further be adapted and configured to calculate a transformation function, denoted [T_{N}], between the abstract reduced set [arP_{N}]∀ I_{N} and the combined user profile set [cP_{N}]∀ I_{N}; and further to use the transformation function [T_{N}], or a derivative thereof, to calculate a set of abstract reduced user profiles [arP_{N}] pertaining to users comprised in a relative complement to the common set of users I_{N}, thereby enabling the service provider S_{N} to create an enhanced service recommendation R_{N} to a user comprised in the relative complement to the common set of users I_{N}.

The system may further be adapted and configured to store the transformation function [T_{N}] ∀ U_{N}∪U_{N-1} or a derivative thereof, in a service transformation database, thereby enabling later retrieval.

The system may further be adapted and configured to store [arP_{N}] ∀ U_{N}∪U_{N-1} in an abstract user profile database, thereby enabling later retrieval.

The system may further be adapted and configured to operate in an iterative, or recursive, manner for each received new service specific set of user profiles [P_{N}] based on the derivatives [arP_{N}] and T_{N}, from previous iterations, thereby enabling system learning.

The system may further be adapted and configured to transform orthogonally through Singular Value Decomposition factorization.

The system may further be adapted and configured to reduce through principal component analysis.

The system may further be adapted and configured to reduce through obtaining a best rank r approximation.

The system may further comprise a memory unit adapted and configured to interact with the processing unit, and within which the abstract user profile database and the service transformation database are implemented.

A second aspect of the invention is a method for enabling, facilitating and accuracy enhancing personalized service recommendations via a network to a user using a new service, denoted S_{N}, comprising the steps of

in a server:
via an input/output network interface

receiving a service specific set of user profiles, denoted [P_{N}], of user attributes classifying individual consumption history of a set of service users, denoted U_{N}, of the new service S_{N};
in the processing unit

combining the service specific set of user profiles, denoted [P_{N}], of user attributes and a set of previously received set of user attributes, denoted [P_{N-1}], or a derivative thereof, classifying a common set of users, denoted I_{N}, into a combined set of user profiles, denoted [P_{N}:P_{N-1}], for the set of common users I_{N};

transforming orthogonally the combined set of user profiles [P_{N}:P_{N-1}] into a set [aP_{N}] of abstract user profiles that are minimized in dimension;

reducing the abstract set [aP_{N}] to an abstract reduced set, denoted [arP_{N}], of the user attributes having the highest variance; thereby enabling enhanced personalized service recommendation to a user comprised in the common set I_{N} of users.

The method according the second aspect of the invention may comprise the further steps of
in the processing unit

calculating a transformation function, denoted [T_{N}], between the abstract reduced set [arP_{N}] and the combined user profile set [P_{N}:P_{N-1}], such that [P_{N}] for I_{N} equals [T_{N}]·[arP_{N}];

using the inverse, denoted [T⁻¹_{N}], of [T_{N}] to calculate a set of abstract reduced user profiles [arP_{N}] pertaining to users comprised in the relative complement to the common set of users I_{N}, thereby enabling the service provider S_{N} to create an enhanced service recommendation R_{N} to a user comprised in the relative complement to the common set of users I_{N}.

The method according the second aspect of some embodiments of the invention may comprise the further steps of storing [T_{N}], [T⁻¹_{N}], or a derivative thereof, in a service transformation database, thereby enabling later retrieval.

The method according the second aspect of some embodiments may comprise the further steps of storing [arP_{N}] in an abstract user profile database, thereby enabling later retrieval.

The method according the second aspect of some embodiments may comprise the further steps of iteratively repeating the method for each received new service specific set of user profiles [P_{N}] based on the derivatives [arP_{N}] and T_{N}, from previous iterations, thereby enabling system learning.

At least one transforming step comprises Singular Value Decomposition factorization. At least one reducing step comprises principal component analysis. At least one reducing step comprises obtaining a best rank r approximation.

A third and fourth aspect of some embodiments of the present invention are a computer program comprising program code configured to perform any of the above method steps when the program code is executed by a computer; and a computer program product comprising program code stored on a computer readable medium for performing the same respective method steps when said product is executed by a computer.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1a illustrates the general principle of gathering subjective and objective user data [P] as a function f of the service interaction of a group U of users using a service S, and using that data to generate product recommendations R to individual users uᵢ comprised in U.

FIG. 1b illustrates how exemplary user groups U_{M} and U_{F} pertaining to respective exemplary services U_{M} and U_{F} may benefit from aggregate user data.

FIGS. 2a and b illustrate how personalized service recommendations to users UN of a new service using a new service S_{N} may be enabled, facilitated and accuracy enhanced through iterations according to one embodiment of the invention.

FIG. 3a is a schematic illustration of a networked server system according to the embodiments of the invention.

FIG. 3b illustrates a networked server system in a network.

FIG. 4 is a diagram illustrating the learning and the learned operation of a system according to embodiments of the invention.

### DETAILED DESCRIPTION

A potential solution to this problem is presented below. At least some embodiments of the present invention apply a user space representation to perform cross domain, or service, recommendation with the addition of reinforced learning.

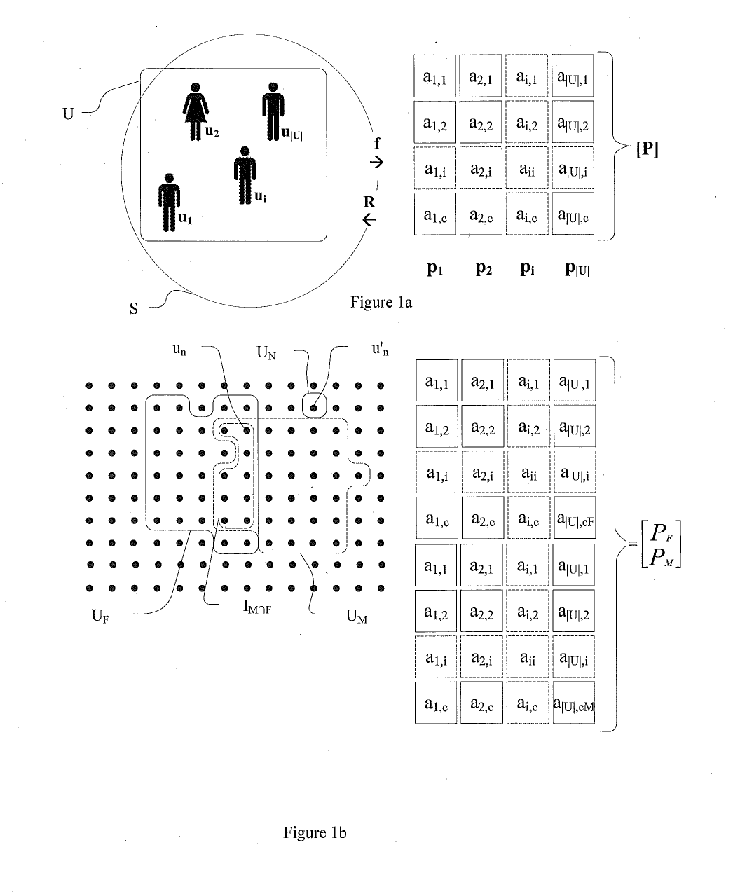

Certain concepts forming a basis for common understanding will now be explained in relation to FIG. 1 a. User data denotes a user's individual consumption history, including ratings and explicit data such as demographics etc. A user profile p, pertaining to a user u, comprises domain specific classification. The user profile p is a function of user u's user data and service specific classification rules and parameters. In practice P is often formatted as a vector of attributes pertaining to various classification categories. For a music service, the classification categories may e.g. be “Jazz”, “Pop”, “Disco”; for a feature film service the categories may be “Action”, “Drama” and “Thriller”; for a literature service the categories may be “Novels”, “Children”, “Business” etc.

For the purpose of this patent application, a domain equals a service, e.g. a web service delivering media content or products. For a set U of users of the service a set of user profiles may be formatted as a matrix, where each column corresponds to a certain user's user profile vector. Each row of the user profile matrix is then a vector comprising various attributes pertaining to a certain classification category. The number of columns in the matrix can thus be referred to as the user dimension of the matrix, and the number of columns of the matrix can be referred to as the category dimension.

How to select and implement a classification method in a content service is beyond the scope of this patent application. The combined user profiles in a content service S with an incumbent set U of users, the set comprising |U| users, and c categories may be expressed as a (c×|U|) matrix [P] for the |U| users, where each column equals one vector pᵢ.

$$[ P ] = {[ \overline{\begin{matrix}{a}_{1 , 1} & {a}_{1 , 2} & ⋯ & {a}_{1 , \vert U \vert} \\ {a}_{2 , 1} & {a}_{2 , 2} & ⋯ & {a}_{2 , \vert U \vert} \\ ⋮ & ⋮ & ⋱ & ⋮ \\ {a}_{c , 1} & {a}_{c , 2} & ⋯ & {a}_{c , \vert U \vert}\end{matrix}} ]}_{(}$$

An attribute a_{2,1} comprised in the matrix [P] above equals a second service specific categorization of a first user u₁:s associated user profile vector p₁.

With reference to FIG. 1b, a user profile matrix [P_{F}] can be defined as endogenous to a film service S_{F} if all user profile vectors p come from and are classified in relation to users that currently subscribe to the service S_{F}, or shorter put: if [P_{F}] ∀ U_{F}. A service-endogenous user profile can be used as input to attribute-filtering, content-based, or collaborative, so as to obtain a content recommendation R_{F} for a user among the set of users U_{F}.

The larger the set of users U, the higher the recommendation accuracy. Therefore, with reference to FIG. 1b, if an exemplary service S_{M} offers music content with a certain correlation to feature film content offered by the service S_{F}, and/or there exists a set of users U_{M} ∩ U_{F}=I_{M∩F} that are common to both services, the service S_{F} could benefit from using S_{M}'s classification matrix [P_{M}] ∀ U_{M}, even though [P_{M}] ∀ U_{M} is not endogenous, i.e. exogenous, to the service S_{F}. Note that [P_{M}] ∀ U_{M} is exogenous to S_{F} even though it partly profiles S_{F}-users in the user set I_{M∩F}. S_{F} can use [P_{M}] ∀ I_{M∩F} for content based recommendations R_{F} to I_{M∩F}. S_{F} can further use [P_{M}] ∀ U_{M} for collaborative recommendations R_{F} to each single user comprised in the set U_{M}. Yet further, S_{F} can use [P_{M}] for the relative complement D_{M\F}=U_{F}\U_{M}([P_{M}] ∀ D_{M\F}) for content based recommendations to the set difference D_{M∀F} even though the users D_{M\F} has no previous experience from S_{F}. Reciprocally, S_{M} can use [P_{F}] ∀ I_{M∩F} for content based recommendations R_{M} to I_{M∩F} and so on, in analogy with the above. Since the recommendations would be based on only one service's user profile, the accuracy may be limited, though.

However, it is possible to increase the accuracy of recommendations by allowing the information sharing to go both ways, i.e.

$${S}_{M} {⇔}^{[ P ]} {S}_{F} .$$

For a c_{M}×|I_{M∩F}| matrix [P_{M}] ∀ I_{M∩F} where c_{M} denotes the number of music categories, duplex information sharing may be enabled through creating a combined user profile (c_{F}+c_{M})×|I_{M∩F}| matrix

$$[ {cP}_{FM} ] = [ {P}_{F} \text{:} {P}_{M} ] = [ \begin{matrix}{P}_{F} \\ {P}_{M}\end{matrix} ]$$

If the latter is factorized, e.g. using Singular Value Decomposition, a transformation matrix [T] can be derived such that an aggregate user profile [P_{F∪M}]=[T]*[P_{F}:P_{M}].

In theory, the operator of service S_{F} may acquire and combine, exogenous user profiles from an endless amount of services, but in practice, S_{F}'s recommendation engine will succumb to the massive computational demands of matrix operations when the category dimension, i.e. the row dimension, equals the sum of all services' categories Σc→∞. However, if it can be assumed that the contents offered by the services S_{F} and S_{M} are correlated, it is possible to make an orthogonal transformation, e.g. using Principal Component Analysis, such that the matrix row dimension of can be reduced to x where x=<c_{F}+c_{M}.

Ideally, if this process is repeated for each available exogenous service classification [P], a state may be reached where the reduced row dimension is nearing a maximum number of non-correlated attributes xₘₐₓ, such that the combined matrix [P_{F∪M}]→[rP_{F∪M}].

In a real classification engine application, with real data, however, there will likely be deviations even for correlated attributes, which means that the processing and storage demands of the classification engine application will exceed what is technically and financially desirable or feasible. Therefore, there is a practical upper limit to how many services can be exploited based on the above.

However, a service operator may still get a desired effect from a subset of the combined data corresponding to a matrix of row dimension r, where r is small enough with regard to processing and storage capacity. Further, the desired effect can be optimized if that subset comprises the r most highly correlated attributes. According to the Eckart-Young theorem, such a matrix—

a rank r approximation (r×|U_{M∩F}|) matrix

$$[ arP ] = [ \overline{\begin{matrix}{p}_{1 , 1} & {p}_{1 , 2} & ⋯ & {p}_{1 , \vert U \vert} \\ {p}_{2 , 1} & {p}_{2 , 2} & ⋯ & {p}_{2 , \vert U \vert} \\ ⋮ & ⋮ & ⋱ & ⋮ \\ {p}_{r , 1} & {p}_{r , 2} & ⋯ & {p}_{r , \vert U \vert}\end{matrix}} ]$$

of the aggregate reduced row user profile [rP] would be the best approximation of such a subset in the least-squares sense. Hence r is the minimum row dimension required to adequately represent all available services.

A service S_{N} may exploit a rank r approximation user profile [arP] derived from the incumbent services S_{M}, S_{F}, etc. If there exist a set of users U_{N} ∀ U_{M ∪ F} that have used S_{N}, they can be given informed content-based recommendations to a user u_{N} ∀ U_{N}.

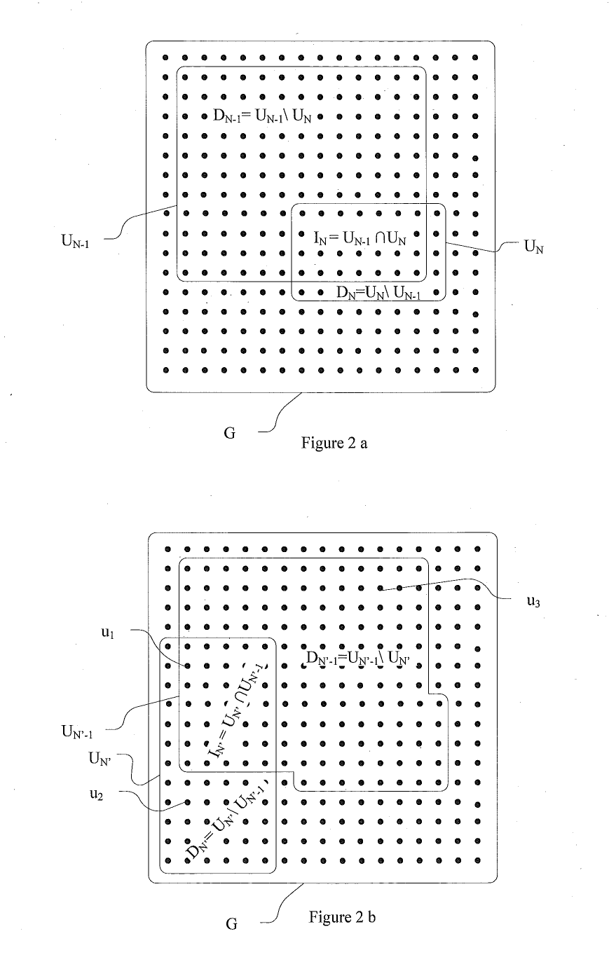

FIG. 2a is a Venn diagram illustrating different sets in the user dimension. A set of all users in a cluster of incumbent services on the market is denoted U_{N-1}. U_{N-1} is a subset to a set of global users G. G may be the set of all users registered in a certain subscription register. G is the global set of users that may use any services S that source the recommendation-enabling method. It is assumed that the provider of the recommendation-enabling method owns or controls some type of Customer Relations Management resource based on G.

For the purpose of this patent application, the following denotation will be used. A set of all users in a new service S_{N} is denoted U_{N} ⊂ G. An intersection set I_{N} is a set of users common to sets U_{N-1} and U_{N}, so that I_{N}=U_{N-1}∩U_{N}. The relative complement, or set difference, D_{N}=U_{N}\ U_{N-1} contains all users that is comprised in U_{N} but not in U_{N-1}. In analogy with this, D_{N-1}=U_{N-1}\ U_{N}. The cardinality, i.e. amount of users, in a set U is denoted |U|. A user profile [P_{N}] ∀ U_{N} that is the result of a classification of user data obtained within service S_{N} may be referred to as endogenous to service S_{N}. If nothing else is mentioned, [P_{N}] ∀ U_{N} is a (c_{N}×|U_{N}|) matrix, where c_{N} is the number of attribute classes for each user profile vector comprised in [P_{N}]. In general [arP] is a reduced rank r approximation user profile derived from a user profile [P].

Based on what is accounted for above, in the general case the following holds for iteration N: if [arP_{N-1}] is available for a set of users U_{N-1}, and there exists a common set of users I_{N}, it is possible to calculate the user profile [P_{N}] for users D_{N-1}. Access to [P_{N}] for users D_{N-1}, in turn enables product recommendation in service S_{N} for the users in D_{N} who are new to the service S_{N}, based on classifications made in incumbent services Sᵢ for i=1 to N−1. For an initial service S₁, [P₁] may be used as a [arP₀].

A service S_{N} may perform a classification to obtain a user profile [P_{N}] ∀ U_{N}. Such a user profile can be said to be endogenous to S_{N}, because it is based on data that is caused by the interaction of users in the set U_{N,} while using the service S_{N}. An abstract user profile [arP_{N-1}] for users U_{N-1} is available from the recommendation product provider. This abstract user profile can be said to be exogenous to the service S_{N}. This exogenous abstract user profile is based on data from all incumbent services that are currently customers to the recommendation product provider, and it profiles, i.e. describes, the users comprised in the set U_{N-1}. The exogenous abstract user profile [arP_{N-1}] is an (r_{N-1}×|U_{N-1}|) matrix, where r_{N-1}<(c_{N-2}+c_{N-1}).

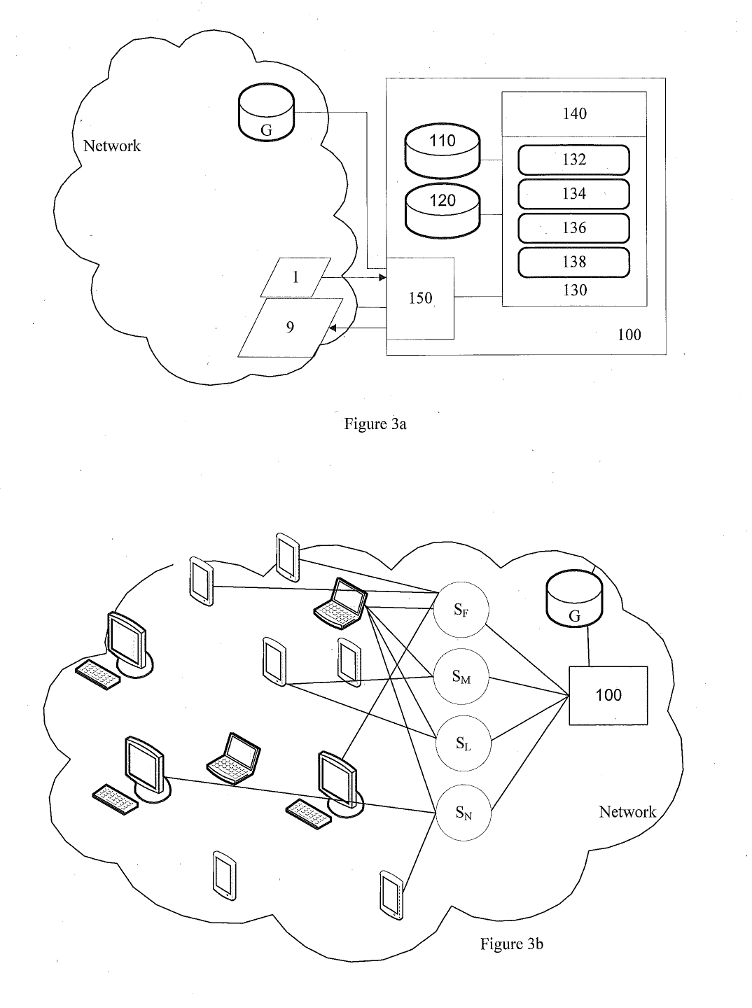

A networked service recommendation server system 100 according to embodiments of the present invention will now be described in relation to FIGS. 3a and b. The system 100 enables, facilitates and enhances the accuracy of personalized service recommendations R=f([P]) to a user of a service S_{N}. The system 100 comprises an abstract user profile database 110, a service transformation database 120, an input/output network interface 150, and a processing unit 130. The processing unit is adapted and configured to provide user selection functionality 132, dimension reduction functionality 134, profile update functionality 136 and service recommendation functionality 138. The system is adapted and configured to receive service specific set of user profiles from a new service S_{N} via the input output interface 150. The received set is denoted [P_{N}]∀ U_{N} and it has a user dimension and an attribute classification category dimension.

The system is further adapted and configured to utilize the user selection functionality 132 to select and combine the service specific set of user profiles [P_{N}]∀ U_{N} and a set of previously received set of user profiles, denoted [P_{N-1}]∀ U_{N-1}, or a derivative thereof, into a combined set, denoted [cP_{N}]∀ I_{N}, of user profiles for a set of users I_{N}=U_{N} ∩ U_{N-1}. The system 100 is further adapted and configured to orthogonally transform, with the dimension reduction functionality 134 the [cP_{N}]∀ I_{N} into a set of abstract user profiles, denoted [aP_{N}] ∀ I_{N}, that is minimized in attribute classification dimension and to reduce, in the attribute classification dimension, the abstract set [aP_{N}]]∀ I_{N} to an abstract reduced set, denoted [arP_{N}] ∀ I_{N}, of the user attributes having the highest variance; thereby enabling enhanced personalized service recommendation to a user comprised in the common set I_{N} of users. The system is adapted and configured to operate in an iterative manner, during which the profile update functionality 138 is utilized for intermittent storing of user profiles.

The system is further adapted and configured to perform any combination of the method steps described below.

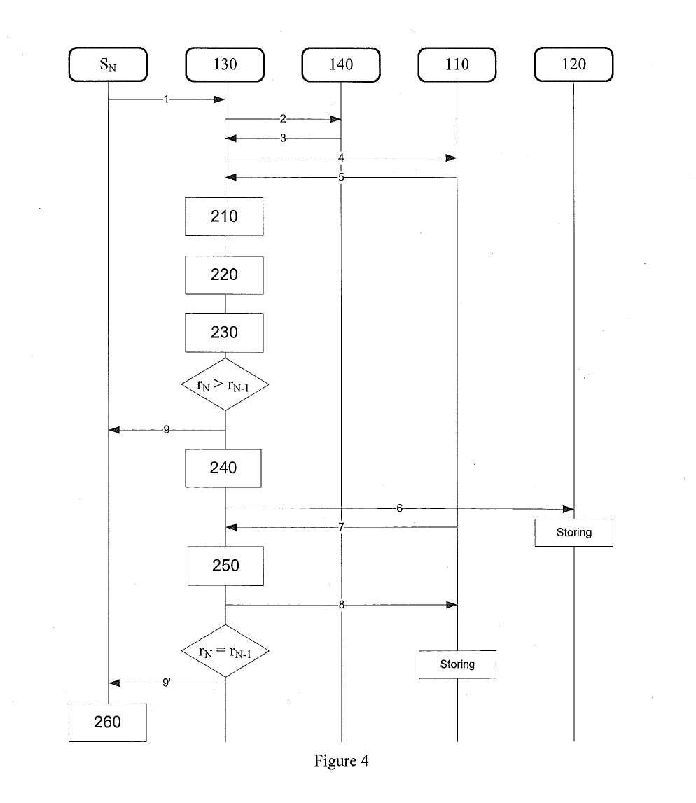

A recommendation method in a networked service recommendation server system 100 according to embodiments of the present invention will now be described in relation to the sequence diagram of FIG. 4. In a first step the processing unit 130 receives, via the interface unit 150, a service specific set of user profiles [P_{N}] of user attributes. This is illustrated with arrow number 1.

These user attributes classify the individual interaction history of a set of users U_{N} of the new service S_{N}. More specifically, [P_{N}] ∀ U_{N}, and it has a user dimension and an attribute classification category dimension.

In order to resolve user identities relating to the received user profile, the processing unit 130 may send an identity resolve request to the optional user identity resolution server 140. This is illustrated with arrow number 2. The request comprises the service specific identities of all users comprised in U_{N} together with a service identifier. The user identity server 140 returns a set of unified user identities pertaining to U_{N}. This is illustrated in arrow number 3. Based on the unified user profiles the processing unit sends a request for a set of abstract user profiles [aP_{N-1}]∀ I_{N} from the abstract user database 110 and receives user profiles pertaining to users U_{N}. This is illustrated with arrows 4 and 5 respectively.

The processing unit 130 may then select a set of resolved user identities I_{N} comprised in U_{N}, that are commonly comprised in a set of users U_{N-1} being classified by a previously received set of user attributes [P_{N-1}], and originating from a single previous service, or a derivative of a previously stored set of user attributes, in aggregate with user attributes from many services. Such a derivative may be a set of abstract user profiles, denoted [aP_{N-1}], or it may be an abstract reduced set of user profiles, denoted [arP_{N-1}]. How these derivatives are defined and derived will be described below.

In a combination step 210, the processing unit 130 then combines [P_{N-1}] ∀ I_{N} with [P_{N-1}] ∀ I_{N} or the derivative thereof, into a combined set of user profiles [cP] ∀ I_{N} so that the attribute classification category dimension is summed while the user dimension remains |I_{N}|.

The combined set may then be transformed orthogonally into a set [aP_{N}] ∀ I_{N} of abstract user profiles that are minimized in attribute classification category dimension. This is performed in a transforming step 220. In practical terms, the combined set of user profiles may be a combined matrix with (c_{N}+r_{N-1}) rows and |I_{N}| columns. Factorization, or Singular Value Decomposition may be used during the orthogonal transformation. The processing unit may calculate, store and update transformation functions needed during this process.

This minimized combined matrix [arP_{N}]∀ I_{N}, and/or its corresponding inverse matrix, may be utilized to obtain a corresponding transponate matrix, thereby enabling enhanced personalized service recommendation to a user comprised in the common set I_{N} of users.

However, it is also possible to use an approximation, an abstract reduced set, [arP_{N}] ∀ I_{N}, of the minimized combined matrix with a reduced amount of rows x. In practice, this may be done through principal component analysis. The minimized matrix may be truncated, so that only the user attributes having the highest variance remains. The truncated matrix is then the best rank r approximation. This further enhances the accuracy of personalized service recommendations to a user comprised in the common set I_{N} of users. The reduction is performed in a reduction step 230.

If the system has already passed a learning phase, the dimension will be the same, and there is no need to update anything else. Therefore the last step in the recommendation phase is to calculate an enhanced user profile set [eP_{N}]=[T_{N}]·[arP_{N}], and send it to the service provider S_{N}. S_{N} can then use [eP_{N}] for enhanced service recommendations R_{N}=f([eP_{N}]). This is illustrated with arrow number 9.

However, if the system is still in the learning phase, the dimension will have increased. Therefore, in order for a user comprised in the relative complement to I_{N} to benefit from enhanced service recommendation accuracy, a transformation function, [T_{N}], must be calculated between the abstract reduced set [arP_{N}] and the combined user profile set [cP], such that [cP]∀I_{N}=[T_{N}]·[arP_{N}].

Therefore, besides T_{N} the transformation functions of all previous services, T_{N-1} has to be calculated in 130 and updated in 120. This may be performed in a calculating transforms step 240.

Further all abstract user profiles [arP_{N}] ∀ D_{N}∪D_{N-1} that have not yet been calculated, should be calculated in a calculation step 250 and updated. The updating is illustrated with arrow number 8.

A person skilled in the art will recognize that the same result may be obtained if a transformation function [T⁻¹_{N}] is calculated, such that [arP_{N}]=[T⁻¹_{N}]·[cP].

Therefore, the inverse [T⁻¹_{N}] of [T_{N}] may be used to calculate a set of abstract reduced user profiles [arP_{N}] pertaining to users comprised in the relative complement to the common set of users I_{N}.

This enables the service provider S_{N} to create an enhanced service recommendation R_{N} to a user comprised in the relative complement to the common set of users I_{N}.

In order to enable later retrieval, [T_{N}], [T⁻¹_{N}], or a derivative thereof may further be stored in a service transformation database. The processing unit 130 calculates the updated transformation functions and, as illustrated by arrow number 6, provides them to the service transformation database 120.

In order to enable later retrieval, [arP_{N}], [aP_{N}] or [cP] may be stored in an abstract user profile database, thereby enabling later retrieval. Alternatively or additionally, [aP_{N}] or [cP] may be stored.

When the above data is retrievable, it is possible to iteratively repeat the above method steps for each received new service specific set of user profiles [P_{N}] based on the derivatives [arP_{N}] and T_{N}, from previous iterations. This iterative mode enables system learning. Note that a service that has already provided the system with a specific set of user profiles in a previous iteration, may so to speak “re-use” the system to gain access to and/or benefit from data that has been aggregated since the system was used the last time. This is enabled through iteratively also calculating transformation functions for user profile sets pertaining to incumbent services, in relation to calculating [T_{N}] for the user profile set pertaining to the service S_{N}.

The last step in the recommendation phase is to calculate an enhanced user profile set [eP_{N}]=[T_{N}]·[arP_{N}], and send it to the service provider S_{N}. S_{N} can then use [eP_{N}] for enhanced service recommendations R_{N}=f([eP_{N}]) in a recommendation step 260. This is illustrated with arrow number 9′.

In a new iteration (for N′=N+1) of the above procedure, this will become the new input [arP_{N′-1}]. Note that we are describing an iterative procedure, and in general a parameter with subscript N−1 is an aggregate parameter. The set U_{N} in the N:th iteration, as illustrated in FIG. 2a, is NOT identical to the set U_{N′-1} in the (N+1):th iteration, as illustrated in FIG. 2b. To exemplify, in an N:th iteration, an exemplary U₅ denotes a set of all users of a new service S_{5,} whereas in the subsequent (N+1):th iteration, a subsequent U₅ denotes the union set of all users in all incumbent services Sᵢ for i=1 to N′−1. When some sufficient amount of services' user profiles have been aggregated in iteration according to the above, the set U_{N-1} will be nearing G.

In order to implement the above as a commercially viable product offering to a service provider of incumbent service Sᵢ or a new service S_{N}, a data processing system must employ a learning functionality that can be trained with exogenous user profiles from incumbent services so as to achieve a reduced rank r approximation user profile [arP], denoted an abstract user profile, that enables optimized recommendations.

While it is known in the art to provide enhanced service recommendations based on endogenous data, known art does not provide all the advantages and benefits that can be obtained with aggregate minimized and reduced, anonymizes abstract user profiles.

Today each system that needs to have a user profile for its users have its own set of information about users, and each of them captures different aspects of information for them. This is while there might be common users among those systems. The information that exist about one same user in different systems may overlap or complete one another, and combining them together may give us new information about that user. The raw user data, such as consumption logs, is service specific and may not be available for other services. However, the data may still be useful for other services. It is a challenge for service providers to share information about the users and still preserve sensitive user data. There are solutions for integration of user profiles. However, they are all based on clustering of user information, rather than dimension reduction, as is the case here.

A potential advantage and benefit that may be provided by at least some embodiments of the present invention is the application of a user space representation to perform cross domain (or service) recommendation with the addition of reinforced learning. One such advantage is that some embodiments can incrementally create a complete user profile from raw user data. It also gives the possibility to the services that dynamically consume data, e.g. recommendation systems, to enrich the user profile that the other ones are using. This approach is different from known processes that offer categorization of users, by analyzing the information captured in number of documents related to users and categorize the users by their relevance to the user profiles in the system. In known processes, a users' tastes plays no role, but the categorization is based on users' proficiencies.

Processes according to some present embodiments are recursive, since each service can affect and enrich the user profile by its data. Systems that can benefit from such classification are recommendation systems. They recognize users' taste after they use the system for enough number of times, and use that information for recommending them suitable content that would be interesting to them. Such systems need enough information for recommending better items; the more they know about users' tastes, the better items they recommend. Therefore, getting input from such classification algorithms help them tune up better and faster. These systems can more easily be initialized by using the user classification information that is achieved by similar systems that have already classified users. The algorithm makes use of dimension reduction (for example SVD or PCA) to a fixed size.

Another possible advantage of the algorithm is that it permits new services to be added. After the model has been trained, the attributes corresponding to the new service is added to the end of the original input-matrix. Then a new training step is performed, which results in an updated model, but with the same dimensionality as the original.

With more available services, more users can contribute and the category dimension can converge to a fixed value and thus provide better estimations.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and sub combinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. A networked server system for enabling, facilitating and accuracy enhancing personalized service recommendations to a user using a new service, denoted S_{N}, comprising an abstract user profile database, a service transformation database, an input/output network interface, and a processing unit adapted and configured to provide user selection functionality, dimension reduction functionality, profile update functionality and service recommendation functionality, the system adapted and configured to:
receive, via a network, from a new service S_{N}, a service specific set of user profiles, denoted [P_{N}]∀ U_{N} and having a user dimension and an attribute classification category dimension;
combine the service specific set of user profiles [P_{N}]∀ U_{N} and a set of previously received set of user profiles, denoted [P_{N-1}]∀ U_{N-1}, or a derivative thereof, into a combined set, denoted [cP_{N}]∀ I_{N}, of user profiles for a set of users I_{N}=U_{N} ∩ U_{N-1};
orthogonally transform [cP_{N}]∀ I_{N} into a set of abstract user profiles, denoted [aP_{N}] ∀ I_{N}, that are minimized in attribute classification dimension; and
reduce, in the attribute classification dimension, the abstract set [aP_{N}]]∀ I_{N} to an abstract reduced set, denoted [arP_{N}] ∀ I_{N}, of the user attributes having the highest variance, to enable enhanced personalized service recommendation to a user comprised in the common set I_{N} of users.

2. The system according to claim 1 further adapted and configured to:
calculate a transformation function, denoted [T_{N}], between the abstract reduced set [arP_{N}]∀ I_{N} and the combined user profile set [cP_{N}]∀ I_{N}; and
use the transformation function [T_{N}], or a derivative thereof, to calculate a set of abstract reduced user profiles [arP_{N}] pertaining to users comprised in a relative complement to the common set of users I_{N}, to enable the service provider S_{N} to create an enhanced service recommendation R_{N} to a user comprised in the relative complement to the common set of users I_{N}.

3. The system according to claim 2 further adapted and configured to:
store the transformation function [T_{N}] ∀ U_{N}∪U_{N-1} or a derivative thereof in a service transformation database to enable later retrieval.

4. The system according to claim 2 further adapted and configured to store [arP_{N}] ∀ U_{N}∪U_{N-1} in an abstract user profile database to enable later retrieval.

5. The system according to claim 2 further adapted and configured to:
operate in an iterative manner for each received new service specific set of user profiles [P_{N}] based on the derivatives [arP_{N}] and T_{N}, from previous iterations to enable system learning.

6. The system according to claim 1, further adapted and configured to transform orthogonally through Singular Value Decomposition factorization.

7. The system according to claim 1 further adapted and configured to reduce through principal component analysis.

8. The system according to claim 1 adapted and configured to reduce through obtaining a best rank r approximation.

9. The system according to claim 1, further comprising a memory unit adapted and configured to interact with the processing unit, and within which the abstract user profile database and the service transformation database are implemented.

10. A method for enabling, facilitating and accuracy enhancing personalized service recommendations via a network to a user using a new service, denoted S_{N}, comprising the steps of:
receiving, via an input/output network interface, a service specific set of user profiles, denoted [P_{N}], of user attributes classifying individual consumption history of a set of service users, denoted U_{N}, of the new service S_{N};
combining, within a processing unit, the service specific set of user profiles, denoted [P_{N}], of user attributes and a set of previously received set of user attributes, denoted [P_{N-1}], or a derivative thereof, classifying a common set of users, denoted I_{N}, into a combined set of user profiles, denoted [P_{N}:P_{N-1}], for the set of common users I_{N};
transforming orthogonally, within the processing unit, the combined set of user profiles [P_{N}:P_{N-1}] into a set [aP_{N}] of abstract user profiles that are minimized in dimension; and
reducing, within the processing unit, the abstract set [aP_{N}] to an abstract reduced set, denoted [arP_{N}], of the user attributes having the highest variance, to enable enhanced personalized service recommendation to a user comprised in the common set I_{N} of users.

11. The method according to claim 10 comprising the further steps performed by the processing unit:
calculating a transformation function, denoted [T_{N}], between the abstract reduced set [arP_{N}] and the combined user profile set [P_{N}:P_{N-1}], such that [P_{N}] for I_{N} equals [T_{N}]·[arP_{N}]; and
using the inverse, denoted [T⁻¹_{N}], of [T_{N}] to calculate a set of abstract reduced user profiles [arP_{N}] pertaining to users comprised in the relative complement to the common set of users I_{N}, thereby enabling the service provider S_{N} to create an enhanced service recommendation R_{N} to a user comprised in the relative complement to the common set of users I_{N}.

12. The method according to claim 11 comprising the further step of storing [T_{N}], [T⁻¹_{N}], or a derivative thereof, in a service transformation database to enable later retrieval.

13. The method according to claim 11 comprising the further step of storing [arP_{N}] in an abstract user profile database to enable later retrieval.

14. The method according to claim 11, comprising the further steps of iteratively repeating the method for each received new service specific set of user profiles [P_{N}] based on the derivatives [arP_{N}] and T_{N}, from previous iterations to enable system learning.

15. The method according to claim 10, wherein at least one transforming step comprises Singular Value Decomposition factorization.

16. The method according to claim 10, wherein at least one reducing step comprises principal component analysis.

17. The method according to claim 10, wherein at least one reducing step comprises obtaining a best rank r approximation.

18. A computer program comprising program code that is configured to perform the steps of claim 10 when executed by a computer.

19. A computer program product comprising program code stored on a computer readable medium and configured to perform the method of claim 10 when executed by a computer.
